(19) United States
(12) Patent Application Publication
(10) Pub. No.: US 2026/0241616 A1
(43) Pub. Date: Aug. 20, 2026

(54) MODULAR PRESSURIZED CONTAINER FOR CURING MATERIALS

(71) Applicant: Matthew U. Bettig, Mattawan, MI (US)

(72) Inventor: Matthew U. Bettig, Mattawan, MI (US)

(21) Appl. No.: 19/329,460

(22) Filed: Sep. 15, 2025

Related U.S. Application Data
(60) Provisional application No. 63/694,372, filed on Sep. 13, 2024.

(51) Int. Cl. B29C 35/02

(52) U.S. Cl. CPC B29C 35/0227; B29C 35/0288

(57) ABSTRACT

A modular pressurized container for curing materials is disclosed. The container includes a selectively removeable lid, a plurality of selectively connecting corner elements, wherein each corner element comprises a sidewall having an overlapping tab on a first end and a corresponding recess for receiving a tab on a second end, an integrally connected base portion substantially perpendicular to the sidewall, and at least one gusset substantially, perpendicularly coupled to the sidewall and the base portion, and a base sealing planar member configured for mechanical attachment to the base portion of the plurality of selectively connecting corner elements.

### CROSS REFERENCE TO RELATED APPLICATIONS

This application claims the benefit of Provisional Application No. 63/694,372 filed on Sep. 13, 2024 which is hereby incorporated herein by reference.

### TECHNICAL FIELD

This disclosure relates to woodworking devices, and more particularly to a modular apparatus for curing materials such as resin.

### BACKGROUND

The statements in this section merely provide background information related to the present disclosure and may not constitute prior art.

Woodworkers are increasingly using epoxy resin within or on their woodworking projects. One popular style using epoxy resin is a “river table”, where a strip of epoxy resin is cured between two wood boards. The epoxy resin is poured as a liquid between the boards and some type of form to keep the liquid in a desired position. The epoxy resin will cure after a duration, which depends upon the depth of the epoxy resin pour. The epoxy resin can be clear or dyed. In some projects, there are decorative elements within the epoxy resin, e.g., rocks.

There are many challenges to an epoxy resin pour and throughout the curing process. One problem is the presence of void spaces which present as bubbles within the epoxy resin when curing. These voids or “bubbles” can make the epoxy resin cloudy, which is undesirable when a transparent epoxy pour is intended. Larger bubbles cured into the epoxy resin are unsightly and can obscure elements within the epoxy, resulting in an inferior product and/or wasted material. Similar problems occur in other materials that solidify such as concrete.

Therefore a need exists for an apparatus to reduce bubbles or air generally within a poured material during the solidification process.

### SUMMARY

A modular pressurized container for curing materials is disclosed. The container includes a selectively removeable lid, a plurality of selectively connecting corner elements, wherein each corner element comprises a sidewall having an overlapping tab on a first end and a corresponding recess for receiving a tab on a second end, an integrally connected base portion substantially perpendicular to the sidewall, and at least one gusset substantially, perpendicularly coupled to the sidewall and the base portion, and a base sealing planar member configured for mechanical attachment to the base portion of the plurality of selectively connecting corner elements.

Certain embodiments of the invention include sidewalls forming a planar-shaped interior walls.

Certain embodiments of the invention include sidewalls forming a elliptical-shaped interior walls.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 shows an exemplary modular pressurized container, in accordance with the present disclosure;

FIGS. 2A and 2B show embodiments of the container without the lid, in accordance with the present disclosure;

FIG. 3A-3D show different perspective views of an exemplary modular corner element, in accordance with the present disclosure;

FIG. 3E shows an enlarged view of a first coupling end on a modular corner element, in accordance with the present disclosure;

FIG. 3F shows an enlarged view of a second coupling end on the modular corner element, in accordance with the present disclosure;

FIGS. 4A and 4B show an exemplary wall element, in accordance with the present disclosure;

FIGS. 5A and 5B show an exemplary wall element, in accordance with the present disclosure;

FIG. 6 shows a portion of an exemplary modular pressurized container having a vertical extending modular wall element, in accordance with the present disclosure;

FIGS. 7A and 7B show the vertical extending modular wall element, in accordance with the present disclosure;

FIG. 8 shows another embodiment of the modular pressurized container, in accordance with the present disclosure;

FIG. 9 shows a partially exploded view of the container with the lid removed from the container portion, in accordance with the present disclosure;

FIG. 10A shows an exploded view of the container without mechanical fasteners, in accordance with the present disclosure;

FIG. 10B shows an exploded view of a plurality of gaskets, in accordance with the present disclosure

FIG. 11 shows an exemplary support frame, in accordance with the present disclosure;

FIG. 12 shows a container portion that may be used in some embodiments, in accordance with the present disclosure;

FIGS. 13A-13C show an exemplary modular corner element, in accordance with the present disclosure;

FIG. 14A shows an embodiment of the container without an assembled lid having a plurality of container portions, in accordance with the present disclosure;

FIG. 14B shows an embodiment of the container without an assembled lid having a plurality of extended container portions, in accordance with the present disclosure;

FIGS. 15A and 15B show exemplary modular wall elements, in accordance with the present disclosure;

FIGS. 16A and 16B show another embodiment of the container having a container portion with an elliptical-shaped interior space, in accordance with the present disclosure;

FIG. 16C shows an embodiment of the container, in accordance with the present disclosure;

FIGS. 17A and 17B show another embodiment of the container having a lift for elevating a piece within the container when under pressure, in accordance with the present disclosure;

FIG. 18 is an exploded view showing an embodiment of the container having an interior liner, in accordance with the present disclosure;

FIG. 19 is an exploded view, depicting portions of an embodiment of components of the container, in accordance with the present disclosure; and

FIG. 20 shows an exemplary embodiment of the sealing planar member,

### DETAILED DESCRIPTION

Reference throughout this specification to “one embodiment,” “an embodiment,” or similar language means that a particular feature, structure, or characteristic described in connection with the embodiment is included in at least one embodiment of the subject matter of the present disclosure. The phrase “in one embodiment,” as used herein does not necessarily refer to the same embodiment, although it may.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” The term “based upon” is not exclusive and allows for being based on additional factors not described, unless the context clearly dictates otherwise. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

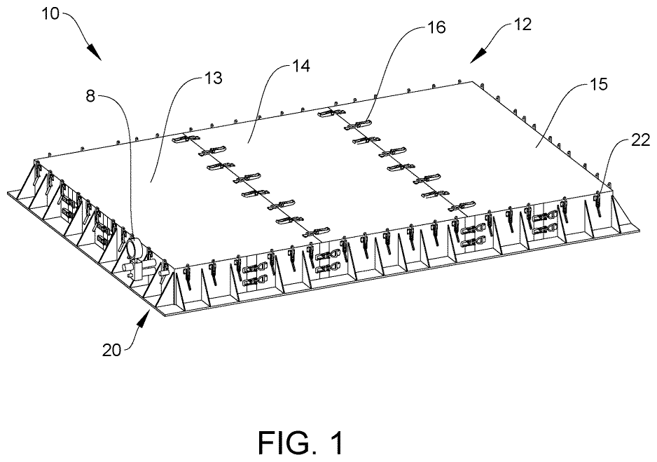

Referring now to the drawings, wherein the depictions are for the purpose of illustrating certain exemplary embodiments only and not for the purpose of limiting the same, FIG. 1 shows an exemplary modular pressurized container 10 that may be used for curing materials such as resin, polymer-based liquids or concrete. As FIG. 1 shows, the container 10 includes a lid 12 and a fortified base portion 20. A pressure sensor 8 may be included. The container 10 includes an inlet for receiving a tube or line from a compressor (not shown). An interior of the container 10 may then be selectively placed under pressure via air supply from the compressor.

The lid 12 may be integrally formed into a single, substantially planar-shaped portion. In some embodiments, the lid 12 is formed of two or more sections, such as first section 13, second section 14, and third section 15. The sections 13, 14, and 15, may be selectively joined via mechanical fasteners such as locking clamps 16. The lid 12 may be coupled to the base 20 via a plurality of locking clamps 22, which may be disposed all along a perimeter thereof.

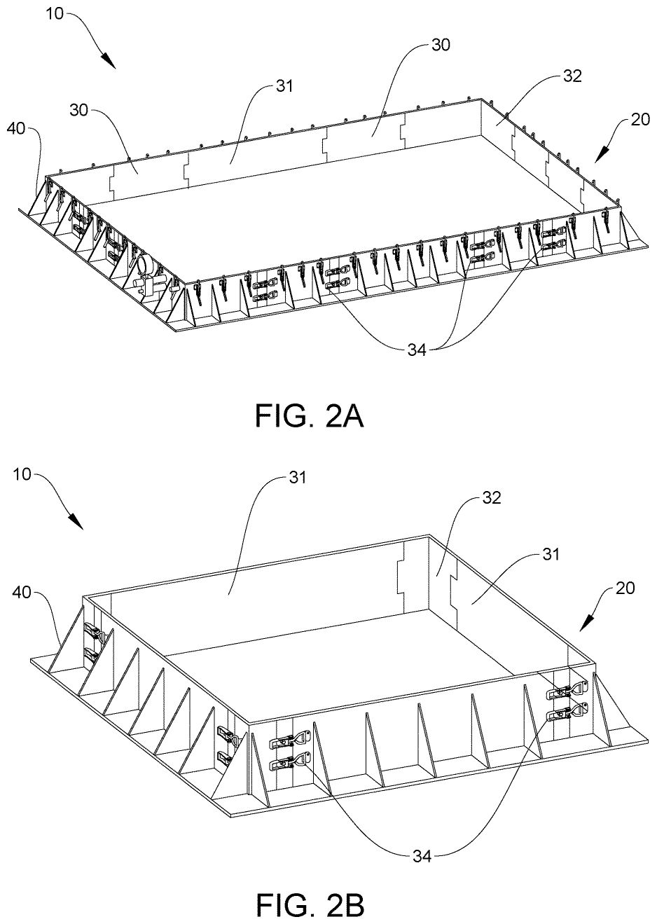

FIGS. 2A and 2B show embodiments of the container 10 without the lid. As FIG. 2 shows, the base 20 includes a sidewall, which is formed of a plurality of modular wall elements 30 and 31 and four modular corner elements 32. The modular elements 30, 31 and 32 selectively lock together to form the base 20. The modular elements 30, 31 and 32 include a plurality of fortifying gussets 40. The modular elements 30. 31 and 32 attach together using a mechanical fastener 34, which may be locking clamps. As FIGS. 2A and 2B show, by varying the number of modular elements 30 and 31, one can construct different sized rectangular-shaped containers.

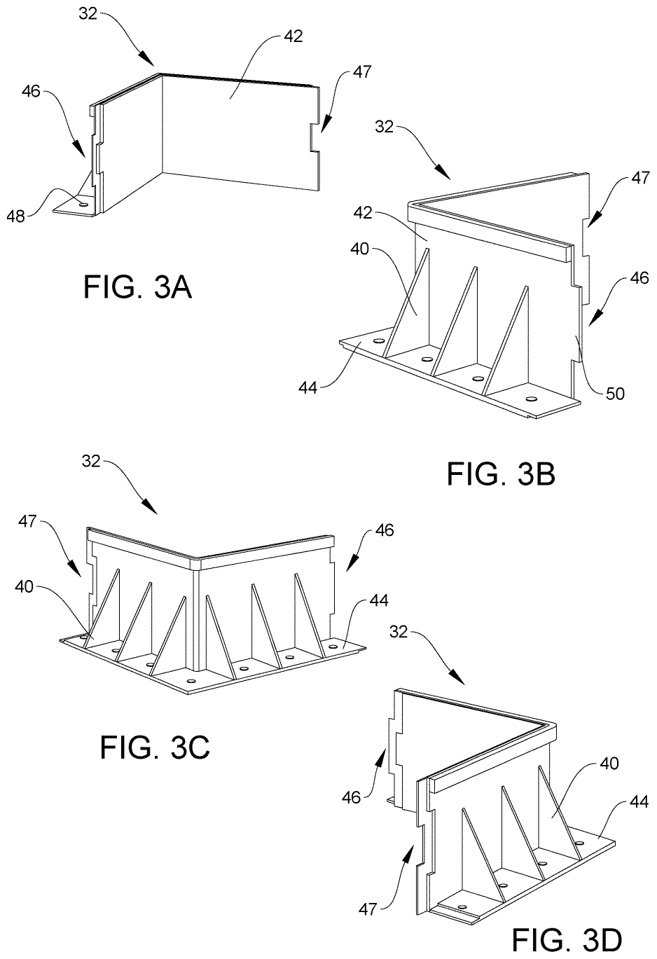

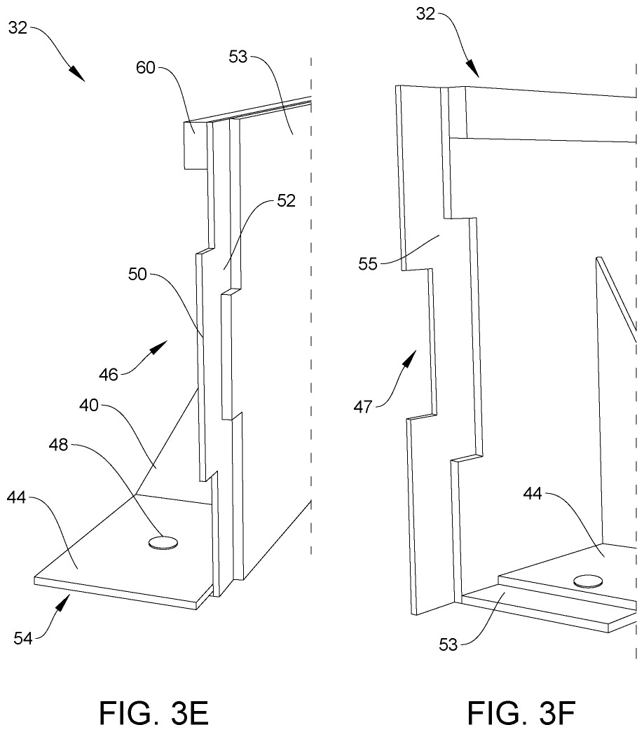

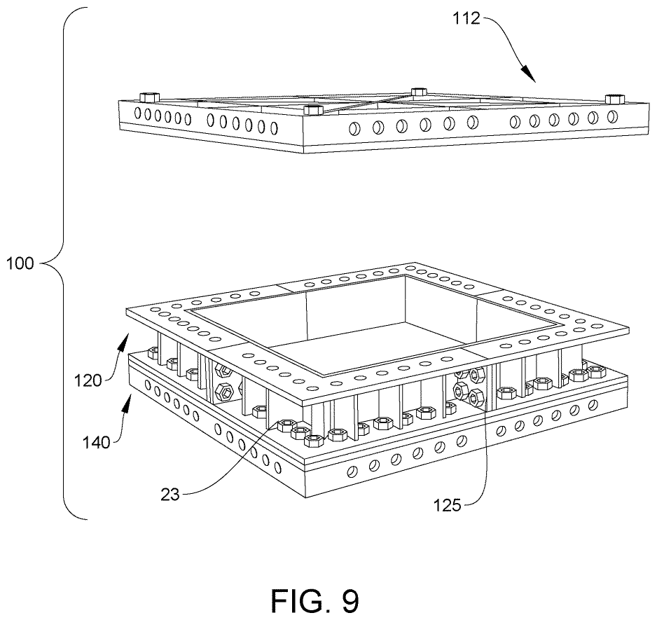

FIG. 3A-3D show different perspective views of an exemplary modular corner element 32. As FIG. 3A-3D show, the modular corner element 32 are formed of a plurality of gussets 40, perpendicular sidewalls 42, and a base support foundation 44. The sidewalls 42 have interior surfaces and exterior surfaces. The base support foundation 44 is perpendicular to the sidewalls 42. The sidewalls 42 have a first coupling end 46 and a second coupling end 47. The base support foundation 44 includes a plurality of apertures 48 to receive a mechanical fastener such as a bolt 23 shown in exemplary FIG. 9. The apertures 48 are preferably coaxially aligned with apertures of the base sealing planar member 144 so that the mechanical fasteners may pass therethrough to aid coupling between the base sealing planar member 144 and the wall elements 30 and 31.

In some embodiments, magnets may be used to couple the wall elements 30 and 31 to the base sealing planar member 144 and/or to the sealing planar member 115.

FIG. 3E shows an enlarged view of the first coupling end 46 on the modular corner element 32. As FIG. 3E shows, the first coupling end 46 has a substantially centrally positioned protrusion 50, forming a flanged portion 52 configured to overlap with a corresponding coupling end such as an end shaped like the second coupling end 47. The flanged portion 52 can be integrally formed with the sidewall 42. An interior surface 53 of the sidewall 42 is stepped from the flanged portion 52.

FIG. 3F shows an enlarged view of the second coupling end 47 on the modular corner element 32. As FIG. 3F shows, the second coupling end 47 corresponds to a shape of the first coupling end 46. The second coupling end 47 includes a second flanged portion 55, configured to overlap the flanged portion 52 when coupled.

The base portion 44 includes an upper overlapped end portion 54, as shown in FIG. 3E and a corresponding underlapped portion 53 as shown in FIG. 3F. When coupled, the portions 53 and 54 create a half-lap joint.

A lining strip 60 may be included to help seal the lid 12. In some embodiments, the lining strip 60 is configured to support the lid 12. The lining strip 60 is preferably coupled on an exterior surface of the sidewall 42.

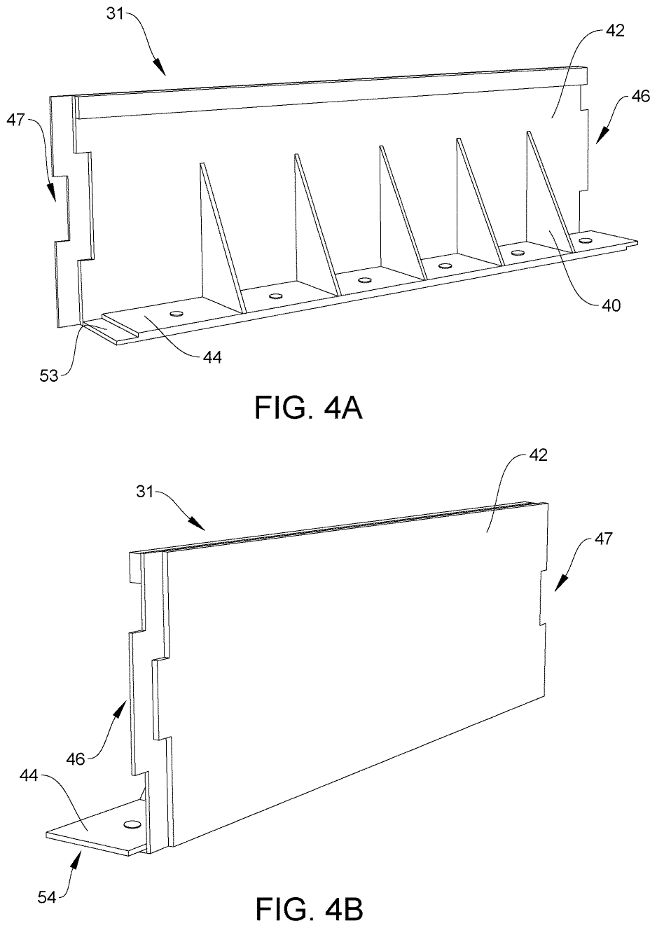

FIGS. 4A and 4B show the exemplary wall element 31. As FIGS. 4A and 4B show, the exemplary wall element 31 includes coupling ends 46 and 47 similar to the modular corner element 32 described hereinabove. The exemplary wall element 31 includes a plurality of gussets 40, perpendicular sidewalls 42, and a base support foundation 44. The sidewalls 42 have interior surfaces and exterior surfaces. The base support foundation 44 is perpendicular to the sidewalls 42. The base portion 44 includes an upper overlapped end portion 54, and a corresponding underlapped portion 53, so that when coupled, the portions 53 and 54 create a half-lap joint.

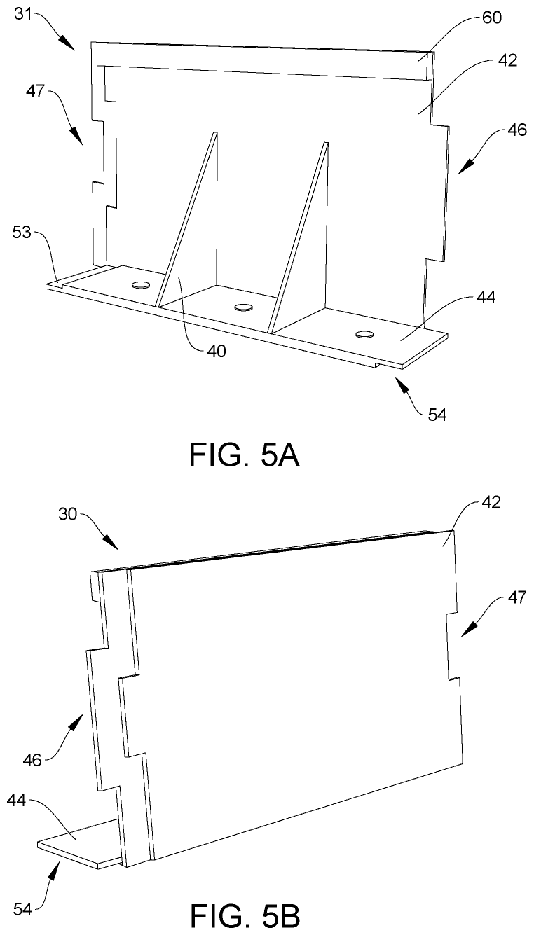

FIGS. 5A and 5B show the exemplary wall element 30. As FIGS. 5A and 5B show, the exemplary wall element 30 includes coupling ends 46 and 47 similar to the wall element 31 and the modular corner element 32 described hereinabove. The exemplary wall element 30 includes a plurality of gussets 40, perpendicular sidewalls 42, and a base support foundation 44. The sidewalls 42 have interior surfaces and exterior surfaces. The base support foundation 44 is perpendicular to the sidewalls 42. The base portion 44 includes an upper overlapped end portion 54, and a corresponding underlapped portion 53, so that when coupled, the portions 53 and 54 create a half-lap joint.

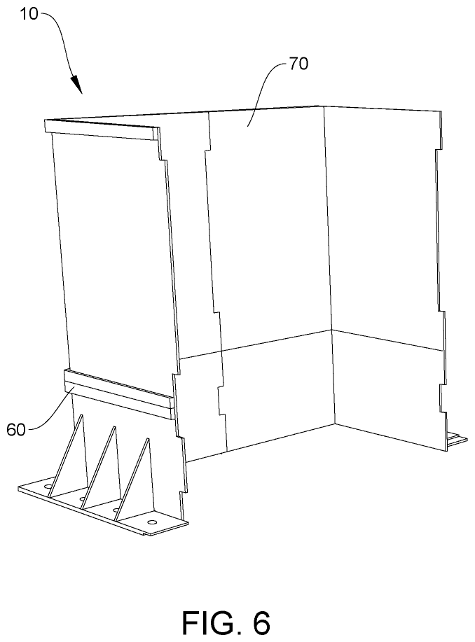

FIG. 6 shows a portion of an exemplary modular pressurized container 10 having a vertical extending modular wall element 70. As FIG. 6 shows, the element 70 is configured to extend a vertical distance of the sidewalls, enabling larger height structures within the container 10. The element 70 is shown as a corner element, however one skilled in the art will readily recognize that sidewall extending elements similar to elements 30 and 31 may be used in some embodiments.

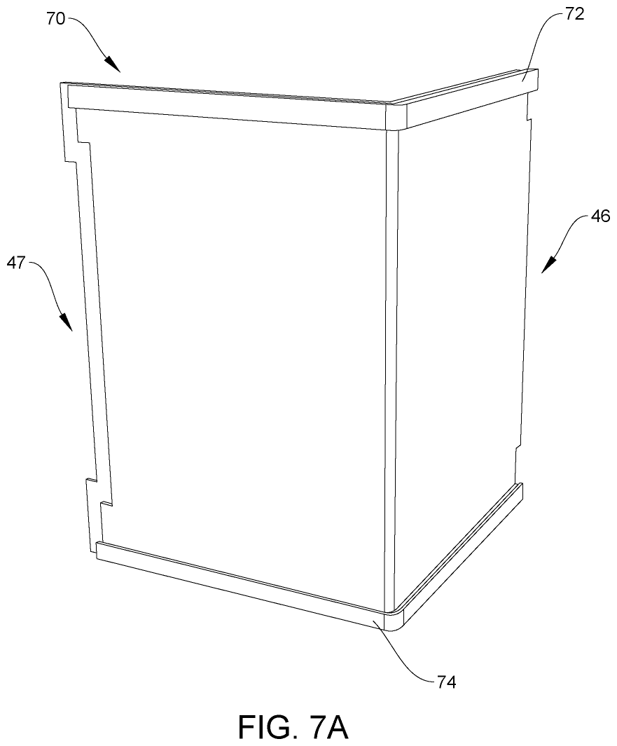

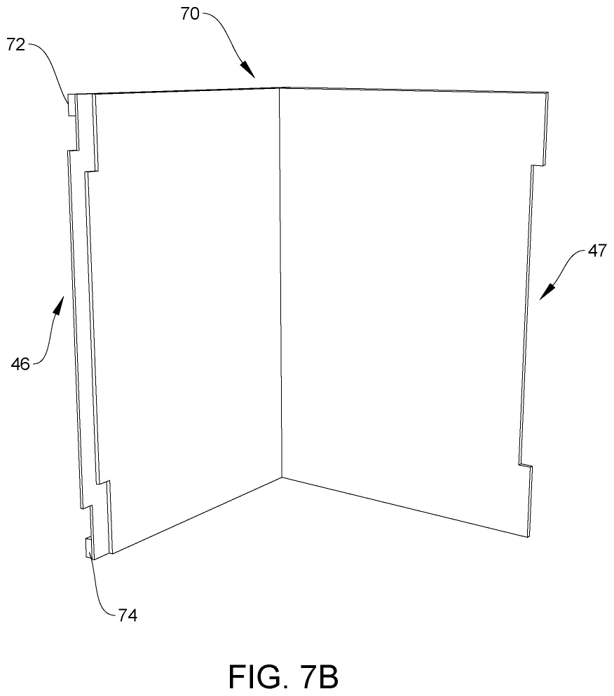

FIGS. 7A and 7B show the vertical extending modular wall element 70. As FIGS. 7A and 7B show, the element 70 may include the coupling ends 46 and 47 similar to the wall elements 30, 31 and the modular corner element 32 described hereinabove. The element 70 may include an upper support strip 72 configured may be included to help seal and/or support the lid 12. Similarly, the element includes a lower support strip 74 to help seal the container 10 and/or support the element 70 to one or more of the elements 30, 31 and/or the modular corner element 32 coupled below the element 70.

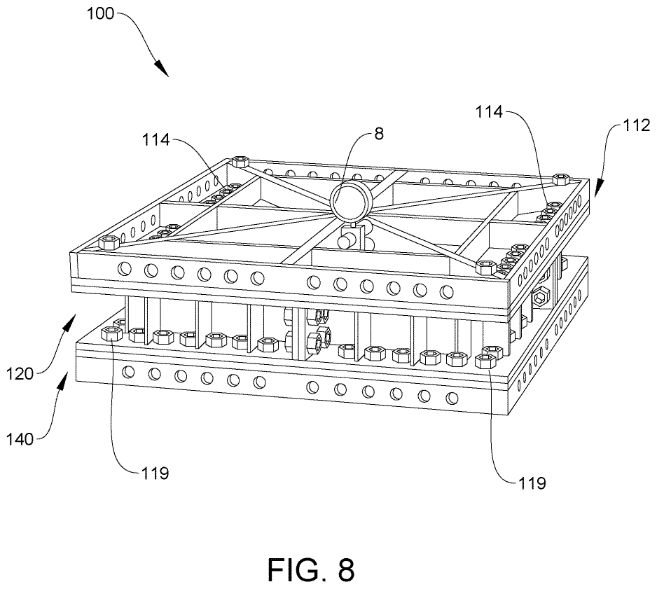

FIG. 8 shows another embodiment of the modular pressurized container 100. As FIG. 8 shows, the container 100 includes a lid 112, an interior container portion 120 and a base portion 140. The container 100 is shown in an assembled state, ready for pressurization of an object. As FIG. 8 shows, the lid 112 is mechanically fastened to the container portion 120 using a plurality of mechanical fasteners 114. In some embodiments the mechanical fasteners 114 are generally circumferentially aligned at predefined distances from one another. The container portion 120 is mechanically fastened to the base portion 140 using a plurality of mechanical fasteners 119. In some embodiments the mechanical fasteners 119 are generally circumferentially aligned at predefined distances from one another.

FIG. 9 shows a partially exploded view of the container 100 with the lid 112 removed from the container portion 120. As FIG. 9 shows, the container portion 120 includes an interior area for receiving an object to hold temporarily under pressure.

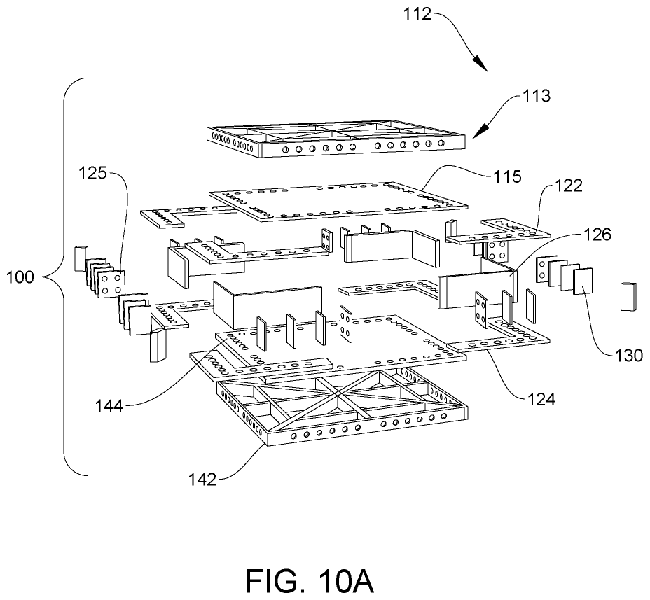

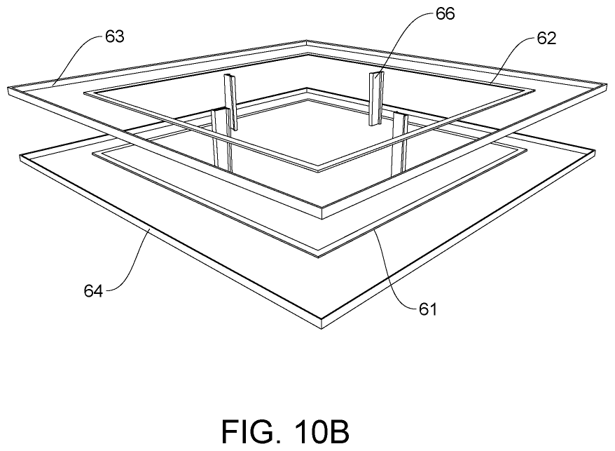

FIG. 10A shows an exploded view of the container 100 without mechanical fasteners. As FIG. 10A shows, the lid 112 includes a support frame 113 and a sealing planar member 115. The container portion 120 is formed of four modular corner elements 132, which each include sidewalls 126, a plurality of gussets 130, an upper support bracket 122 and a lower support bracket 124. In some embodiments, the corner elements 132 include a coupling support member 125 which includes a plurality of apertures from which a mechanical fastener may be fastened therethrough. The coupling support member 125 may be coupled to another coupling support member 125 of another corner element 132 such as shown in FIGS. 8 and 9. The base portion 140 includes a base support frame 142 and a base sealing planar member 144.

The upper support bracket 122 includes a plurality of apertures sized and shaped to receive a mechanical fastener such as a bolt. When the container 10 is assembled the apertures are preferably aligned with apertures in the sealing planar member 115. The lower support bracket 124 includes a plurality of apertures sized and shaped to receive a mechanical fastener such as a bolt. When the container 10 is assembled the apertures are preferably aligned with apertures in the base sealing planer member 144.

For ease of illustration, various gaskets are not shown in FIG. 10A, although there may be one or more coupled between the various components.

While the components in FIG. 10A are shown as separate elements in various embodiments, many of the components may be integrally formed into a single component. For example, in one embodiment, a lower support bracket 124, a sidewalls 126, an upper support bracket 122, and one or more gussets 130 may be formed into a single component.

FIG. 10B shows an exploded view of a plurality of gaskets which may be coupled between components shown in FIG. 10A, for example. As FIG. 10B shows, the container 10 may include an upper outside gasket 63, a lower outside gasket 64, an upper inside gasket 62, a lower inside gasket 61, and a plurality of component gaskets 66.

The upper outside gasket 63 is disposed between the sealing planar member 115 and the four upper support brackets 122. The upper inside gasket 62 is disposed between the sealing planar member 115 and the four upper support brackets 122. The upper outside gasket 63 includes a larger perimeter than the upper inside gasket 62. In this way, gasket 63 can couple to the four upper support brackets 122 proximate to the exterior of the container 10, while gasket 62 can couple to the four upper support brackets 122 proximate to the interior of the container 10. In some embodiments, gaskets 62 and 63 permit the sealing planar member 115 to couple flush to the four upper support brackets 122.

The lower outside gasket 64 is disposed between the base sealing planar member 144 and the four lower support brackets 124. The lower inside gasket 61 is disposed between the base sealing planar member 144 and the four lower support brackets 124. The lower outside gasket 64 includes a larger perimeter than the lower inside gasket 61. In this way, gasket 64 can couple to the four upper support brackets 122 proximate to the exterior of the container 10, while gasket 61 can couple to the four upper support brackets 122 proximate to the interior of the container 10. In some embodiments, gaskets 61 and 64 permit the sealing planar member 144 to couple flush to the four upper support brackets 124.

The gaskets 61, 62, 63, 64, and 66 are mechanical seals configured to fills any potential space between mating surfaces, and to generally inhibit leakage out of the container 100 while under compression.

In some embodiments, the gaskets 62 and 64 are formed of polyurethane and/or PTFE/Teflon based material. In some embodiments, the gaskets 62 and 64 are formed of a material configured to crush between joining surfaces to create a sealed, impermeable joining surface. In some embodiments, the gaskets 62 and 64 are secured to one or more of the surfaces with an adhesive. For example, gasket 62 may be adhered to the sealing planar member 115 and gasket 64 may be adhered to the base sealing planar member 144.

In some embodiments, a thin aluminum spacer, i.e., a crush plates, may also be used in the flanges to maintain true square as the gaskets 62 and 64 compress.

In various embodiments, various gaskets may be used to fit inside the interior wall joints of the container 100. For example, gaskets 68 may be used where the interior sidewalls 126 are coupled together.

In some embodiments, the interior sidewalls 126 are slightly shorter than where the four upper support brackets 122 are disposed, e.g., 1/32 ″ shorter, which provides a recess for gasket 62 on the top and gasket 64 on the bottom from which to couple. In some embodiments, when the support brackets 122 are 1/32″ shorter it allows the gaskets 62 and 64 to have a 1/16″ width.

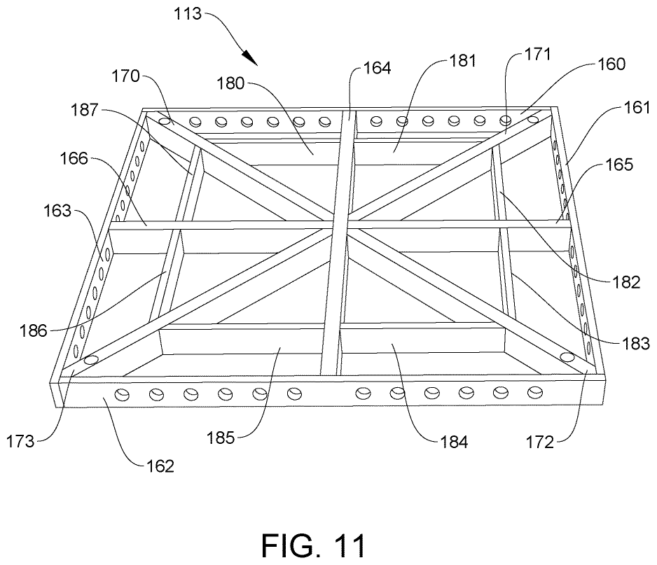

FIG. 11 shows an exemplary lid support frame 113. In some embodiments of the container, this support frame may additionally be used as a base support frame 142. As FIG. 11 shows, the lid support frame 113 is substantially square. In some embodiments the support frame may be other shapes including, e.g., a rectangle. The lid support frame 113 includes perimeter members 160, 161, 162, and 163. The support frame 113 includes a plurality of support member including a first elongated support member 164, which traverses from opposing perimeter members such as members 160 to 162 as shown in FIG. 11.

The first elongated support member 165 may be centrally located support frame 113. Elongated support members 165 and 166 may abut the elongated support member 164 and adjacent perimeter members such as member 161 and 163, respectively, as shown in FIG. 11. Radial support members 170, 171, 172, and 174 may extent radially from a center area of the support frame 113 to one or more perimeter members. In some embodiments, each radial support member 170, 171, 172, and 174 includes a first 45-degree mitered end configured to abut both the first elongated support member 164 and one of the elongated support members 165 and 166, and a second 45-degree mitered end configured to abut two of the perimeter members. For example, a first radial support member 170 abuts perimeter members 163 and 160; a second radial support member 171 abuts perimeter members 160 and 161; a third radial support member 172 abuts perimeter members 161 and 162; and a fourth radial support member 173 abuts perimeter members 162 and 163.

The centrally located support frame 113 may include a plurality of internal support members such as members 180, 181, 182, 183, 184, 185, 186, and 187. These members may be each attached to a radial support member and one of the elongated support members 164, 165 or 166.

In some embodiments, the support frame 113 is integrally formed, such as via casting and/or machining.

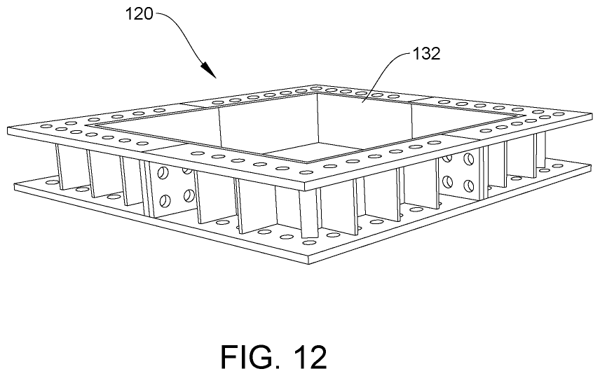

FIG. 12 shows a container portion 120 that may be used in some embodiments. As FIG. 12 shows, the container portion 120 is formed of four modular corner elements 132.

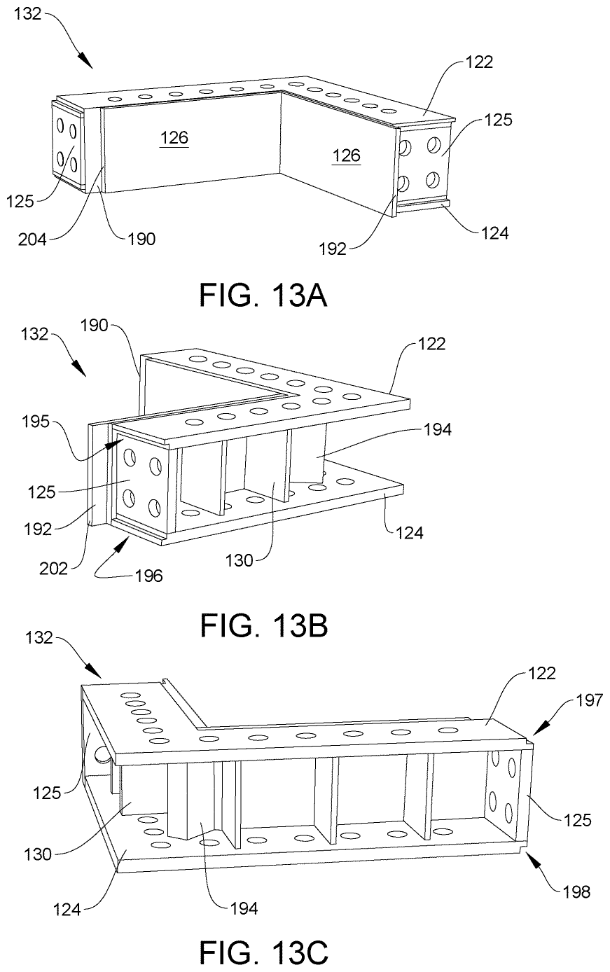

FIGS. 13A-13C show an exemplary modular corner element 132. As FIGS. 13A-13C show, the modular corner element 132 includes interior sidewalls 126, a plurality of gussets 130, an upper support bracket 122 and a lower support bracket 124.

In some embodiments, the upper support bracket 122 and the lower support bracket 124 are substantially L-shaped. In some embodiments, a first end of the upper support bracket includes a recess or rabbeted end 195 configured to receive an opposingly recessed piece. The rabbeted end 195 is sized and shaped to couple to an opposing end of another upper support bracket of another corner element, such an end could be shaped like end 197 in various embodiments. In some embodiments, a first end of the lower support bracket includes a recess or rabbeted end 196 configured to receive an opposingly recessed piece. The rabbeted end 196 is sized and shaped to couple to an opposing end of another lower support bracket of another corner element, such an end could be shaped like end 198 in various embodiments.

The sidewalls 126 include, in some embodiments, an extended tab 192 for overlapping a corresponding recessed area 190 in another sidewall of another corner element. In some embodiments, when the interior area is pressurized, the tab 192 presses against the recessed area 190, sealing the interior space.

In some embodiments, the modular corner element 132 can include a radial support member 194. The radial support member 194 make be configured to support the upper and lower support brackets 122 and 124.

In some embodiments, an end 202 of the tab 192 may be slightly larger than a recessed portion 204 of a corresponding recessed area 190 in order to make a press-fit connection.

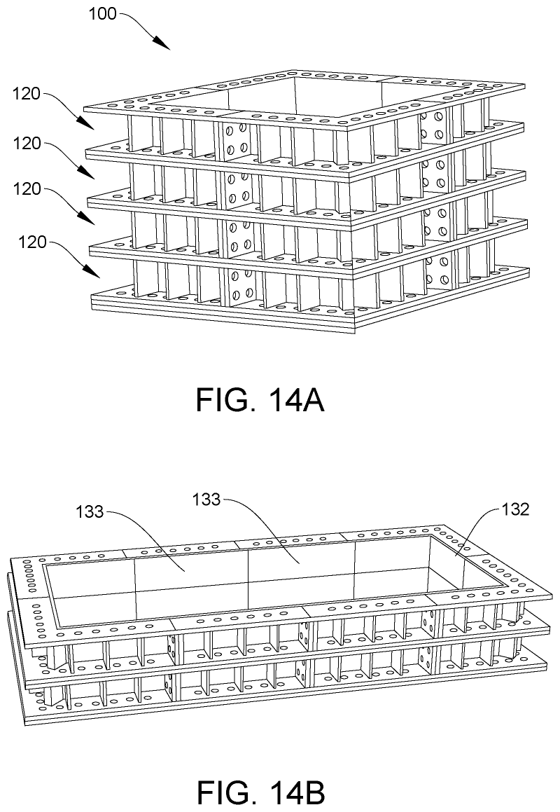

FIG. 14A shows an embodiment of the container 100 without an assembled lid having a plurality of container portions 120. In this way, the interior space of the container 100 can be preferentially adjusted based upon an item to be pressurized. The container portions 120 are shown without mechanical connections for ease of illustration.

FIG. 14B shows an embodiment of the container 100 without an assembled lid having a plurality of extended container portions 120. The container portions 120 are extended by coupling modular wall elements 133 to the modular corner elements 132. While the container in FIG. 14B shows an extended container portion 120 with two modular wall elements 133 on two sides, one skilled in the art will readily recognized that less or more wall elements 133 may be included or excluded. In this way, the interior space of the container 100 can be preferentially adjusted based upon an item to be pressurized. The container portions 120 are shown without mechanical connections for ease of illustration.

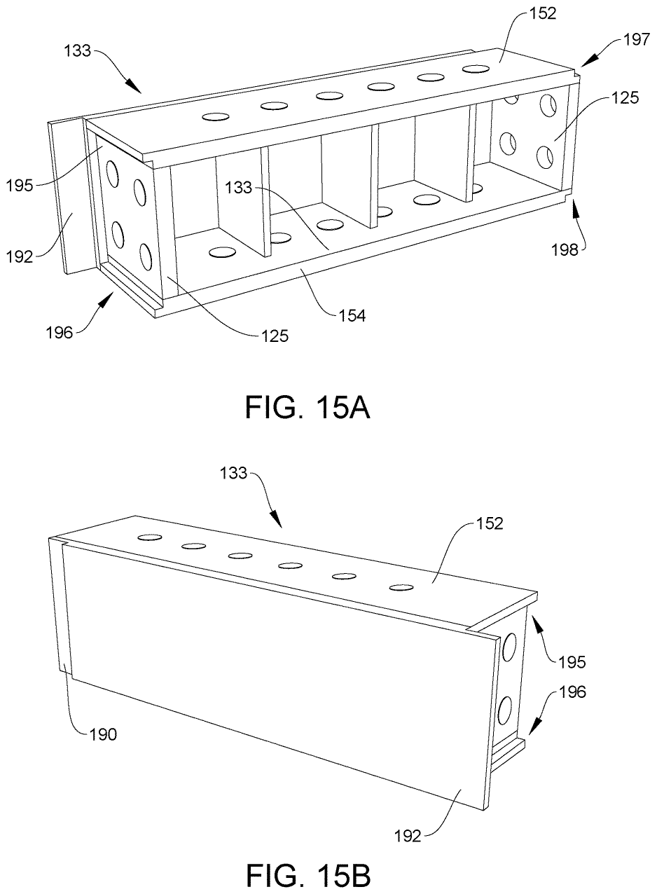

FIGS. 15A and 15B show exemplary modular wall elements 133. As FIGS. 15A and 15B show, the modular wall elements 133 includes interior sidewalls 126, a plurality of gussets 130, an upper support bracket 152 and a lower support bracket 154.

In some embodiments, the upper support bracket 152 and the lower support bracket 154 are substantially planar-shaped. In some embodiments, a first end of the upper support bracket includes a recess or rabbeted end 195 configured to receive an opposingly recessed piece. The rabbeted end 195 is sized and shaped to couple to an opposing end of another upper support bracket 152 of a corner element or modular wall element, such an end could be shaped like end 197 in various embodiments. In some embodiments, a first end of the lower support bracket 154 includes a recess or rabbeted end 196 configured to receive an opposingly recessed piece. The rabbeted end 196 is sized and shaped to couple to an opposing end of another lower support bracket of a corner element or modular wall element, such an end could be shaped like end 198 in various embodiments.

The sidewalls 126 include, in some embodiments, an extended tab 192 for overlapping a corresponding recessed area 190 in another sidewall of another corner element. In some embodiments, when the interior area is pressurized, the tab 192 presses against the recessed area 190, sealing the interior space. In some embodiments, an end of the tab 192 may be slightly larger than a recessed portion of a corresponding recessed area 190 in order to make a press-fit connection.

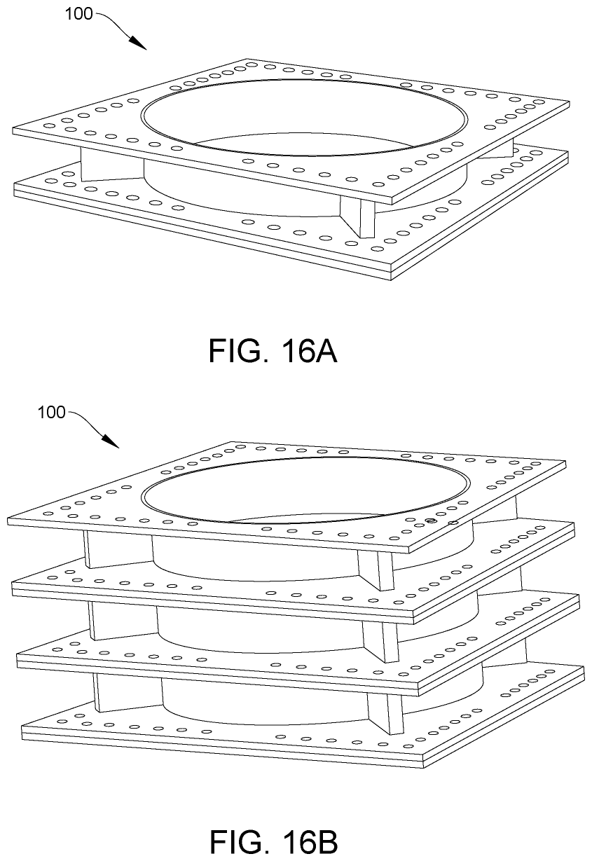

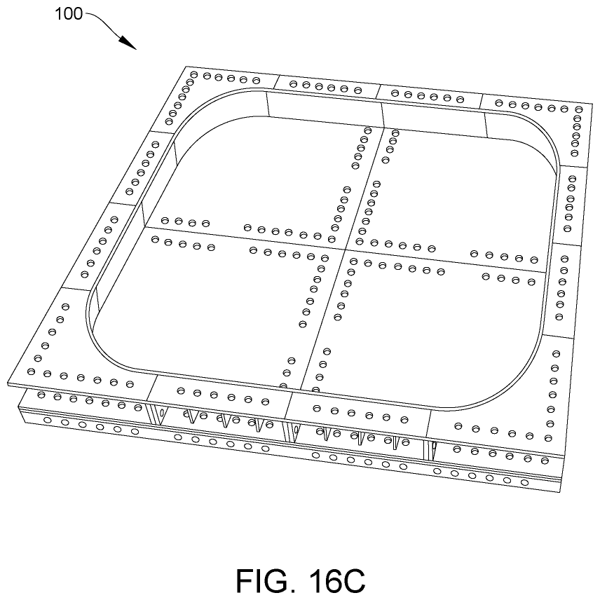

FIGS. 16A and 16B show another embodiment of the container having a container portion 120 with a circular-shaped interior space. FIG. 16C shows an embodiment with a curved interior space formed by curved sidewalls at the corner positions. The container portions 120 may be stackable. The container portions 120 are shown without mechanical connections for ease of illustration.

Elements of the container 10 and 100 may be formed of any number of materials including, e.g., metals such as aluminum, iron, steel, or stainless steel but could be formed with other materials such as polymer, acrylic, resin, etc.

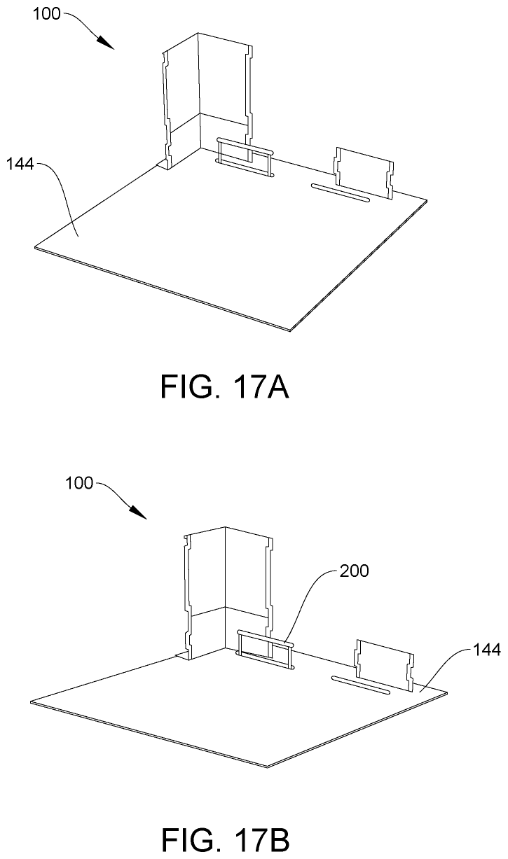

FIGS. 17A and 17B shows an exemplary portion of a container 100 having a lift 200. As FIGS. 17A and 17B show, the lift 200 includes rods and a top surface plate, however it is contemplated that many forms of a lift can be used including a single rod or integral rod and plate structure. The lift 200 is shown as a single, however it is contemplated that a plurality of lifts 200 will be used on base sealing planar member 144. In some embodiments, the rods are sealably connected to the base sealing planar member 144 or sealably coupled through the base sealing planar member 144. In some embodiments, the base sealing planar member 144 may have a plurality of threaded pressure plugs to seal any holes used for rods of the lifts 200.

In some embodiments, the base sealing planar member 144 may include a recess 210 so that the lift 200 may sit flush when in a non-elevated state. In this way, a piece within the container may sit flush on an internal surface of the base sealing planar member 144.

The lifts 200 are sized and shaped to elevate a piece, e.g., such as a woodworking project with uncured resin, within the container 100. The lifts 200 may be used to help remove a cured piece from the container 10 after curing.

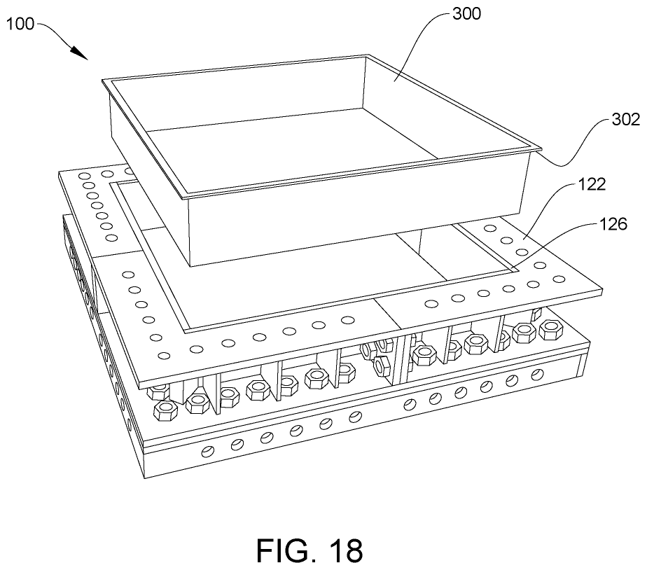

FIG. 18 shows an exemplary exploded view of a container 100 having an interior sleeve 300 configured to function as a liner. The sleeve 300 may be formed of a single-piece silicone or polyurethane sleeve/liner formed to the inner dimensions of the container 100. In some embodiments, a top portion of the liner 300 may include a flanged end 302 configure to overlap a top surface of the upper support brackets 122 and the sidewalls 126. In this way, the flanged end 302 may function as a gasket, being squeezed between the sealing planar member 115 and the top surface of the upper support brackets 122 and the sidewalls 126.

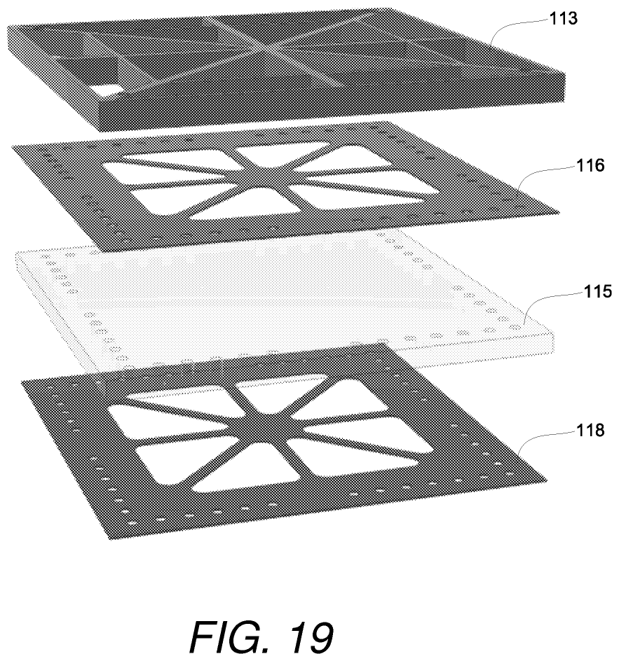

FIG. 19 is a partial exploded view of some components of the container 100. As FIG. 19 shows, in some embodiments, the sealing planar member 115 may be transparent. A reinforcement portion 116 may be included between the sealing planar member 115 and the support frame 113, and a second reinforcing portion 118 may be included below the sealing planar member 115. In some embodiments, the reinforcement portions 116 and 118 are formed of steel and the transparent sealing planar member 115 is formed of an acrylic-based material. The support frame 113, the first and second reinforcement portions 116 and 118, and the sealing planar member 115 may be coupled together using mechanical fasteners such as bolts.

As FIG. 19 shows, the reinforcement portions 116 and 118 include a plurality of spokes from a center portion to a rectangular, perimeter portion, which define a plurality of interior triangular-shaped openings.

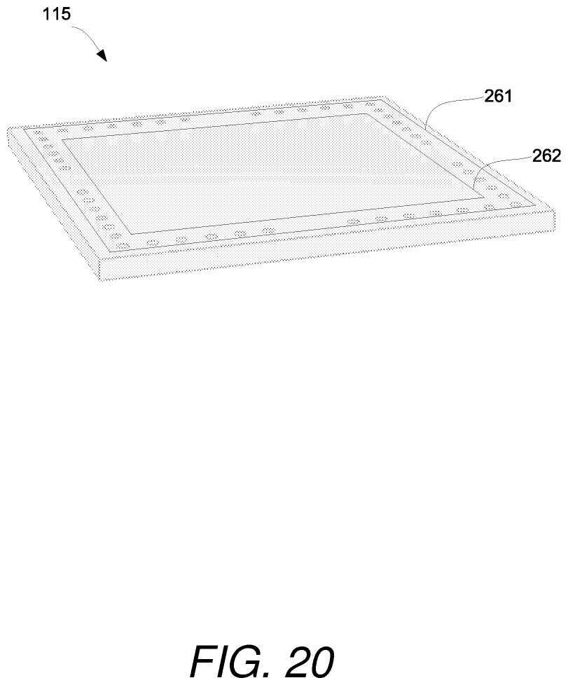

FIG. 20 shows an exemplary embodiment of the sealing planar member 115. FIG. 20 shows a surface configured to receive the reinforcement portion 118. As FIG. 20 shows, the surface of the sealing planar member 115 may include recesses 261 and 262 for receiving gaskets. As described hereinabove, gaskets used with the container 100 are mechanical seals configured to fills any potential space between mating surfaces, and to generally inhibit leakage out of the container 100 while under compression.

In various embodiments, the support frame 113 and/or the base support frame 142 may include thermal components to regulate temperature within the container. In some embodiments, a thermal blanket, i.e., a device having integrated electrical heating wires configured to disperse thermal energy by using an electrical current to heat thin, resistant elements embedded in its fabric, providing consistent warmth through a combination of conduction and convection may be included.

In some embodiments, integrated thermal galleries may be included within the support frame 113 and/or the base support frame 142. In this way, thermal energy may be communicated through the galleries via, e.g., piping liquid into and out of the galleries.

In some embodiments, a thermal radiator may be included within the container.

Throughout the specification and claims, the following terms take at least the meanings explicitly associated herein, unless the context dictates otherwise. The meanings identified below do not necessarily limit the terms, but merely provide illustrative examples for the terms. Similarly, the phrase “in some embodiments,” as used herein, when used multiple times, does not necessarily refer to the same embodiments, although it may. As used herein, the term “or” is an inclusive “or” operator, and is equivalent to the term “and/or,” unless the context clearly dictates otherwise. The term “based, in part, on”, “based, at least in part, on”, or “based on” is not exclusive and allows for being based on additional factors not described, unless the context clearly dictates otherwise.

Examples in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The term “plurality” can be defined as “at least two.”

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

1. A modular pressurized container for curing materials, the container comprising:
a selectively removeable lid;
a plurality of selectively connecting corner elements, wherein each corner element comprises a sidewall having an overlapping tab on a first end and a corresponding recess for receiving a tab on a second end, an integrally connected base portion substantially perpendicular to the sidewall, and at least one gusset substantially, perpendicularly coupled to the sidewall and the base portion; and
a base sealing planar member configured for mechanical attachment to the base portion of the plurality of selectively connecting corner elements.

2. The modular pressurized container of claim 1, further comprising:
a rectangular-shaped gasket configured for sealing the lid and the plurality of selectively connecting corner elements.

3. The modular pressurized container of claim 1, wherein the base portions of the plurality of selectively connecting corner elements each include at least one aperture for receiving a mechanical fasteners and wherein the base sealing planar member includes a plurality of apertures for receiving mechanical fasteners to connect to the plurality of selectively connecting corner elements.

4. The modular pressurized container of claim 1, further comprising:
a removeable interior sleeve.

5. The modular pressurized container of claim 1, further comprising:
a plurality of upper support brackets coupled to the selectively connecting corner elements and gussets, wherein the upper support brackets have a top surface higher than a top surface of the sidewall of the selectively connecting corner elements forming a recess; and
a rectangular-shaped gasket configured for sealing the lid and the plurality of selectively connecting corner elements configured to couple in the recess.

6. The modular pressurized container of claim 1, further comprising:
a plurality of locking clamps configured to selectively couple the selectively connecting corner elements to one another; and
a plurality of locking clamps configured to selectively couple the selectively connecting corner elements to the lid.

7. The modular pressurized container of claim 1, wherein the modular pressurized container further comprises an inlet port for receiving pressurized air, and wherein the plurality of selectively connecting corner elements, the base sealing planar member, and the lid form a sealed internal space for receiving an object.

8. The modular pressurized container of claim 1, further comprising:
a base support frame for supporting the base sealing planar member, wherein the base support frame includes a plurality of apertures for selectively receiving mechanical fasteners to couple to at least the base sealing planar member; and
a lid support frame for supporting the lid, wherein the lid support frame includes a plurality of apertures for selectively receiving mechanical fasteners.

9. The modular pressurized container of claim 1, further comprising:
at least two modular wall elements for coupling between the corner elements, wherein each modular wall elements comprises a second sidewall having a second overlapping tab on a first end for coupling to the recess of a corner element and a second corresponding recess for receiving the tab of a corner element on a second end, a second integrally connected base portion substantially perpendicular to the second sidewall, and at least one gusset substantially, perpendicularly coupled to the second sidewall and the second base portion.

10. The modular pressurized container of claim 1, further comprising:
a plurality of upper support brackets coupled to the selectively connecting corner elements and gussets;
wherein the plurality of selectively connecting corner elements, gussets, the base sealing planar member, and the plurality of upper support brackets form a first container portion; and
wherein the first container portion is stackable with a second container portion.

11. The modular pressurized container of claim 10, wherein the corner elements of the first container portion are integrally connected and include rounded sidewalls to form an elliptical-shaped interior space; and
wherein the first container portion is stackable with a second container portion.

12. The modular pressurized container of claim 10, wherein the corner elements of the first container portion comprise rounded sidewalls.

13. The modular pressurized container of claim 1, further comprising:
a lift sealably coupled through the base sealing planar member configured to selectively raise and lower to elevate a piece within the container; and
wherein the base sealing planar member comprises an internal surface having a second recess sized and shaped for the lift to sit flush when in a non-elevated state.

14. A modular pressurized container for curing materials, the container comprising:
a selectively removeable lid;
a plurality of selectively connecting corner elements, wherein each corner element comprises a sidewall having an overlapping tab on a first end and a corresponding recess for receiving a tab on a second end, an integrally connected base portion substantially perpendicular to the sidewall, and at least one gusset substantially, perpendicularly coupled to the sidewall and the base portion, wherein the base portion comprises a second overlapping tab on a first end of the base portion and a corresponding recess on an opposing end of the base portion;
a plurality of upper support brackets coupled to the selectively connecting corner elements and gussets; and
a base sealing planar member configured for mechanical attachment to the base portion of the plurality of selectively connecting corner elements.

15. The modular pressurized container of claim 14, further comprising:
a base support frame for supporting the base sealing planar member, wherein the base support frame includes a plurality of apertures for selectively receiving mechanical fasteners to couple to at least the base sealing planar member; and
a lid support frame for supporting the lid, wherein the lid support frame includes a plurality of apertures for selectively receiving mechanical fasteners.

16. The modular pressurized container of claim 14, wherein the upper support brackets have a top surface higher than a top surface of the sidewall of the selectively connecting corner elements forming a recess; and
a rectangular-shaped gasket configured for sealing the lid and the plurality of selectively connecting corner elements configured to couple in the recess.

17. The modular pressurized container of claim 14, wherein the base portions of the plurality of selectively connecting corner elements each include at least one aperture for receiving a mechanical fasteners and wherein the base sealing planar member includes a plurality of apertures for receiving mechanical fasteners to connect to the plurality of selectively connecting corner elements.

18. A modular pressurized container for curing materials, the container comprising:
a selectively removeable lid;
an inlet port for receiving pressurized air;
a plurality of selectively connecting corner elements, wherein each corner element comprises a sidewall having an overlapping tab on a first end and a corresponding recess for receiving a tab on a second end, an integrally connected base portion substantially perpendicular to the sidewall, and at least one gusset substantially, perpendicularly coupled to the sidewall and the base portion, wherein the base portion comprises a second overlapping tab on a first end of the base portion and a corresponding recess on an opposing end of the base portion;
a plurality of upper support brackets coupled to the selectively connecting corner elements and gussets, wherein the upper support brackets have a top surface higher than a top surface of the sidewall of the selectively connecting corner elements forming a recess; and
a base sealing planar member configured for mechanical attachment to the base portion of the plurality of selectively connecting corner elements;
a base support frame for supporting the base sealing planar member, wherein the base support frame includes a plurality of apertures for selectively receiving mechanical fasteners to couple to at least the base sealing planar member;
a lid support frame for supporting the lid, wherein the lid support frame includes a plurality of apertures for selectively receiving mechanical fasteners; and
a rectangular-shaped gasket configured for sealing the lid and the plurality of selectively connecting corner elements configured to couple in the recess.

19. The modular pressurized container of claim 18, wherein the base portions of the plurality of selectively connecting corner elements each include at least one aperture for receiving a mechanical fasteners and wherein the base sealing planar member includes a plurality of apertures for receiving mechanical fasteners to connect to the plurality of selectively connecting corner elements.

20. The modular pressurized container of claim 18, wherein the plurality of selectively connecting corner elements, gussets, the base sealing planar member, and the plurality of upper support brackets form a first container portion; and
wherein the first container portion is stackable with a second container portion.

21. The modular pressurized container of claim 20, wherein the corner elements of the first container portion are integrally connected and include rounded sidewalls to form an elliptical-shaped interior space; and
wherein the first container portion is stackable with a second container portion.

22. The modular pressurized container of claim 18, further comprising:
a lift sealably coupled through the base sealing planar member configured to selectively raise and lower to elevate a piece within the container; and
wherein the base sealing planar member comprises an internal surface having a recess sized and shaped for the lift to sit flush when in a non-elevated state.

23. The modular pressurized container of claim 18, wherein the base sealing planar member is transparent.

24. The modular pressurized container of claim 23, wherein the base sealing planar member further comprises:
an upper reinforcement planar member, a transparent middle planar member, and a lower base sealing planar member, wherein the upper reinforcement planar member is configured for mechanical connection to a first surface of the transparent middle planar member and wherein the lower base sealing planar member is configured for mechanical connection to a second, opposing surface of the transparent middle planar member.

25. The modular pressurized container of claim 24, wherein the upper and lower base sealing planar members comprises a plurality of spokes from a center portion to a rectangular portion, defining a plurality of interior triangular-shaped openings.

26. The modular pressurized container of claim 18, further comprising an interior temperature control device.
